(19) United States
(12) Patent Application Publication
(10) Pub. No.: US 2007/0059142 A1
(43) Pub. Date: Mar. 15, 2007

(54) "Mdporta-lift" transportable, transformable, telescoping, leightweight, cantilevered trolley track, half ton capacity material conveying lift

(76) Inventor: Michael Frank Dambroseo, Pinckney, MI (US)

Correspondence Address: Michael Frank Dambroseo, 9485 Cedar Lake Rd., Pinckney, MI, 48169, US

(21) Appl. No.: 11/504,374

(22) Filed: Aug. 15, 2006

Related U.S. Application Data
(60) Provisional application No. 60/712,208, filed on Aug. 30, 2005.

(51) Int. Cl. B66C 1/02

(52) U.S. Cl. 414/561

(57) ABSTRACT

A “truss frame” lift apparatus having an “extended reach” beyond its supporting framework lifting capability which is supported by three legs. A lift that is welded fabricated from a combination of square tubing; telescoping square tubing; round hollow or round solid bar stock; ninety degree angle brackets; flat plate stock and several nuts and bolts, whereby multiple adapters are used to customize set up for use ranging from (steeply sloped to flat) roofs, vehicles, boats, decks, docks warehouses or any other conceived use where lifting and transferring from one elevation to another is required. This lift design provides means of use in a multitude of ways by assembling interchangeable components with locking pins to either front or rear leg(s). This lift is anchored or ballasted depending on method of set up at its rear support leg.

### FIELD OF THE INVENTION

The present invention relates to material conveying apparatuses and, more particularly to one that can be quickly installed on a minimum surface area of three feet by seven feet on most any angled or flat surface (or combination of) whether mobile or fixed using one or a combination of special attachment adapters and can be used by one or more persons almost anywhere.

### BACKGROUND OF THE INVENTION

The lack of a jib type lifting apparatus product that is a comparably functional replacement for fixed and mobile cranes, which is lightweight, quickly set up; detachably connected to its fixed, moveable or pivoting mounts and is convertible to almost unlimited setup requirements and locations; almost infinitely adjustable, in height and width; transportable, and that one average person can set up for use almost anywhere. More specifically this device design would require it to function so as to replicate the path of motion necessary to convey any object (“up; over; and down”) like fixed or mobile cranes. This mini type lift apparatus would need to lift objects to an elevated surface weighing less than a half ton and up to five feet in diameter as much as multiple stories above the ground; have a boom that extends its lift point beyond the plane of its supporting framework so as to be able to lift up to five foot diameter objects up along a wall of a multiple story building then, laterally move object, then set object down onto an elevated surface.

How to eliminate the necessity of having to carry construction equipment and materials up/down ladders over 30 feet to rooftops etc. as a self employed carpenter who has a physicaly limiting health conditon.

Could a lifting device design be created that could eliminate a substantial amount of people from having to lift and move heavy objects at work or home in a practical cost effective and multifunctional package which is easy to use and operate?

The followings problems would have to be overcome in order to create a workable final design based on a considerable amount of thought and research of lifting devices.

1. Device has to contain the ability to be adjustable for set-up on any angled roof or flat surface.

2. Device has to contain the ability to be adjustable in width for mechanically connecting mounting adapters to structural members or for more or less clearance between support legs depending on location/application setup requirement and size of object.

3. All components of the lift must be light enough for one average person easily handle and setup.

4. Somehow the load must travel inboard and outboard of its structural framework to get beyond the edge of a roof so load can have adequate clearance to any vertical wall or obstruction as it is raised or lowered.

5. Lift apparatus should have a safe load limit for objects of maximum one half ton or less and up to five feet in diameter as well as carry roll, bundled or panel construction materials.

The first prototype was conceived by visualizing how to combine the above criteria with the track and trolley of old hay barns and the design of sheet metal folding saw horses. The result was a hollow sheet metal tube to form a boom with a hand screw jack at one end and two folding legs four feet from the opposite end and a set of two 4 foot tracks mounted side by side on the bottom of the sheet metal frame, and attached to the tracks is an electromechanical hoist attached.

After using the first prototype on an actual work site it revealed several design, packaging, handling and cost deficiencies the need to be resolved. The result of the redesign is the said invention of this application.

Many thousands of portable liftts researched has revealed no other patentented inventions and/or products available with a design that includes a combination of features that make the device capable of various methods of mounting by using interchangable fixtures and that is adjustable in width and height and that has a jib boom with a slidable trolley which has an electro or mecahanicl hoist attached to it, and that one average person can easily handle all components as said invention submitted in this application.

The few similar lifting devices found typically shared only one or two features in common with the lift submitted in this application. Typicaly others compared were missing one or more critical features of said invention of this application. For example a given lifting apparatus would typically be limited to a single fixed installation location with a single method of attachment. When compared to said invention of this application would result in a narrow scope of utility, portability etc. Several types of lifts observed typically require heavy equipment to set them up or do not have a lift point extending beyond its structural frame work as in a jib type of lift submitted in said invention of this application.

The four U.S. patents below have been selected as most comparable prior art observed are described as follows:

Patent No.
Date
Inventor

U.S. Pat. No. 4,621,741
November/1996
Charles W. Boon

U.S. Pat. No. 4,930,970

June/1990
Nita K. Sunderland

U.S. Pat. No. 6,782,973 B1
August/2004
Barlow Hatch

U.S. Pat. No. 7,011,486 B1
March/2006
Robert Anthony Dyer

Other lifting apparatuses in existence have not been designed with interchangeable mounting adapters/elements for multiple methods of attachment, adjustability in height/width or do not have adaptability for using Both a mechanical or electromechanical hoist device and is likely lacking a jib type extended lift point beyond its structural framework or is much to heavy or bulky for one person to set up anywhere feasible. Other devices typically have only one method of set up, i.e. on a flat roof with or with out a parapet wall, fixed in place or affixed to a standard or utility truck bed or are based on the use of a common runged extension ladder and as a result have limited utility etc, in comparison with the submitted invention of this application. Other apparatuses may have hydraulics and or a gas engine included as part of their design, these systems are additional weight, increase purchase price, more maintenance etc.

It is therefore an object of the invention to provide a type of lift apparatus that is transportable, transformable, telescoping, lightweight and simple to use.

It is another object of the invention to make usable for commercial or private use.

It is another object of the invention to make it usable by one person if necessary

It is another object of the invention to convey loads under 1000 pounds in its preferred embodiment.

It is another object of the invention to reduce worker injury, long and short term physical damage to workers and people lifting heavy objects.

It is another object of the invention to make available a mini lift apparatus that is comparably functional to modern mobile cranes.

### SUMMARY OF THE INVENTION

In accordance with the present invention, there is provided a three legged cantilevered jib lift (crane) that has both form and function, it provides the means to convey a load from one elevation to another that is limited in lift height only by type of hoist device attached to its track/main frame. The crane is simple to fabricate from telescoping square and or round tubing, common angle brackets and a few nuts and bolts. Plates and brackets may be shop fabricated if manufactured parts are not desired. Interchangable adapters are used to customize set up ranging from roofs (flat to steeply sloped), vehicles (pick up truck or flat beds), boats, decks, docks warehouses or any other conceived use where lifting and conveying is required. This lift design provides means of use in a multitude of configurations by assembling components with locking pins. It's rear leg must be attached to structural member(s) by lag bolts and a J-hook or at the rear end (front of pickup truck box etc.) or ballast is required at rear leg to offset uplift force of load. This lift may be used in fixed anchored positions, or on casters (with ballast) and is detachable from is mounting base by three locking pins. A staging platform is created by attaching adjustable brackets to the two front legs preferabley when set up is on a steeply angled roof surface also to which crane is attached. Set up can be completed by one individual of sufficent strength in under 1 hour. The heaviest component is about 65 pounds.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of a mdporta-lift in accordance with the invention;

FIG. 2 is an exploded view of a mdporta-lift exploded view as shown in FIG. 1, included are the following components: track, rear leg(s), “a” frame of front support assembly, mid section leg(s) of front support assembly, lower leg(s) of front assembly;

FIG. 3 is a left elevation view of an alternate configuration assembled for sloped surface;

FIG. 4 is a perspective view of an electromechanical hoist adapter assembly;

FIG. 5 is a perspective view of a hoist control handle and attachment bracket;

FIG. 6 is a left perspective view of a mechanical hoist adapter assembly;

FIG. 7 is a perspective view of an angle brace “a” and used in conjunction with long leg exttention at rear of crane;

FIG. 8 is an elevation view of a power cord support arm;

FIG. 9 is a perspective view of a flat surface leg attachment adapter;

FIG. 10 is a perspective view of a pivoting sloped surface leg attachment adapter;

FIG. 11 is an elevation view of a j-hook attachment bolt;

FIG. 12 is a perspective view of an univirsal adapter tee;

FIG. 13 is a perspective view of a pivoting two point connection adapter;

FIG. 14 is a perspective view of a truck bed adapter;

FIG. 15 is a perspective view of a ballast adapter;

FIG. 16 is a perspective view of a parapet wall adapter;

FIG. 17 is a perspective view of an angle brace “b” adapter and extension; and

FIG. 18 is a perspective view of an adjustable platform support bracket.

For purposes of clarity and brevity, like elements and components will bear the same designations and numbering throughout the Figures.

### DESCRIPTION OF THE PREFERRED EMBODIMENT

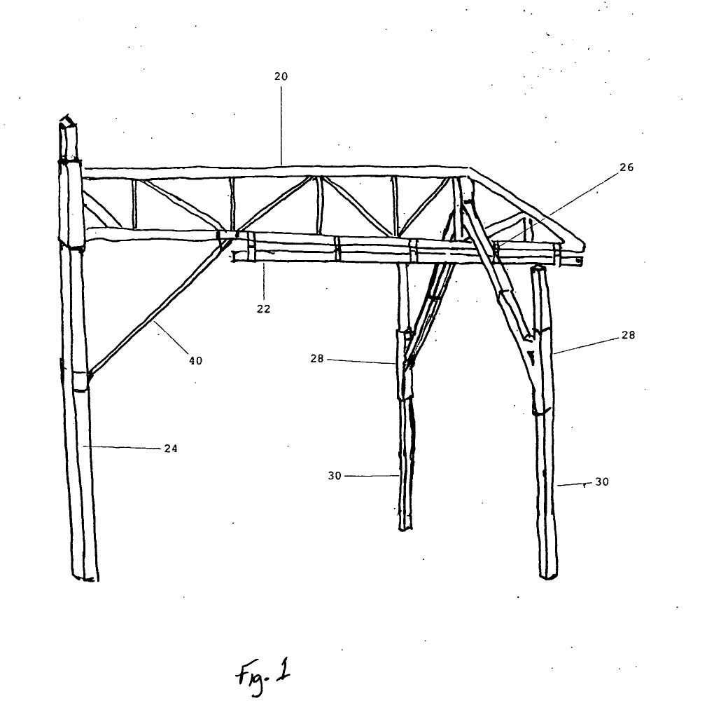

FIG. 1 is a perspective view of a convert-a-crane in accordance with the invention. An object and material lifting and moving device with almost unlimited set up configurations. Whereby installation and attachment is achieved by utilizing one of many combinations of accessory adapters. This invention is intended to lift; “transversely move back and forth (as on a trolley track); and set down the object(S) or material(S) from surface to surface i.e. ground to roof top; ground to vehicle or trailer bed; floor to elevated loft/storage area within a structure; from in or below water surface to boat deck or dock or any other conceived use like a large scale crane. The convert-a-crane can be constructed of many combinations of hollow or solid tubing's or any other suitable material whereby generally the main frame 20 and accessory adapters are welded fabricated and interchangeable with each other according to the connections diagram of this application, they are secured using a form of a locking pin. As shown in FIG. 1 the shape, size and proportion of the main frame and front support assembly components may be increased or decreased in dimension with no change in relationship to each other so as to create a larger or smaller version of the design concept as necessary to meet more specific lifting criteria. It is also possible to achieve same functionality of this design concept by changing the shape or size of the main frame and or cantilever, in any way the quantity of tension and compression webs, spacing or angles of etc., angle braces, overall length, overall height or angular and reinforcement relationship of main frame rail components that would not change the methodology created by the design of this invention which is, to “lift; move; then lower” an object or material. The invention as shown in FIG. 1 having three telescoping legs for supporting itself (and the load) and thereby three possible surface attachment points whereby the rear leg(S) 24 and attachment point being a single telescoping leg is adjustable in height or length by substituting a long leg section (see rear leg(S) 24 for a short leg section, and the front having two legs and support points part of the “A” frame of front support assembly 26 with each of the two front legs consisting of two mid section leg(S) and two lower leg sections and one common section (“A” frame) to connect them to the main frame 20. The “A” frame is connected to the main frame 20 by means of “cross pinning” both angular legs of “A” frame through welded tabs on the main frame 20, along with a doweled alignment pin located on the cross connection bar of the “A” frame into a receiving hole on the bottom rail of the main frame 20 at the correct location. Whereby design purpose of “A” frame of front support assembly 26 as shown in this invention is to allow space for trolley track 22, hoist mfg. by others 68 and load to travel between front support assembly legs and from end to end of trolley track 22. Multiple methods are required to attach invention and accessory adapters to crane to assemble it and make ready for use, one is a locking pin, two is lag bolts, J-hook 48 or ballast adapter 58, details are more fully described in the following figures. Multiple components used in this invention rely upon products manufactured by Unistrut Corporation. although several components could be substituted with products manufactured by others and/or could be custom shop fabricated. Several components could not be practically substituted or custom shop fabricated. Unistrut can provide several surface finishes in addition to plain mill finish products. The Unistrut patented telescoping “Square fit tubing” is critical to incremental adjustability as it is produced with holes located on all four sides that accurately line up with incrementally larger or smaller sizes of tubing manufactured by them whereby a locking pin is inserted from any side to lock two pieces at any location. Several of the main frame 20 components could be standard steel square tubing of sufficient strength and as long a holes are provided a specific locations for attaching track 22, power cord support arm 42, “A” frame of front support assembly 26 etc.

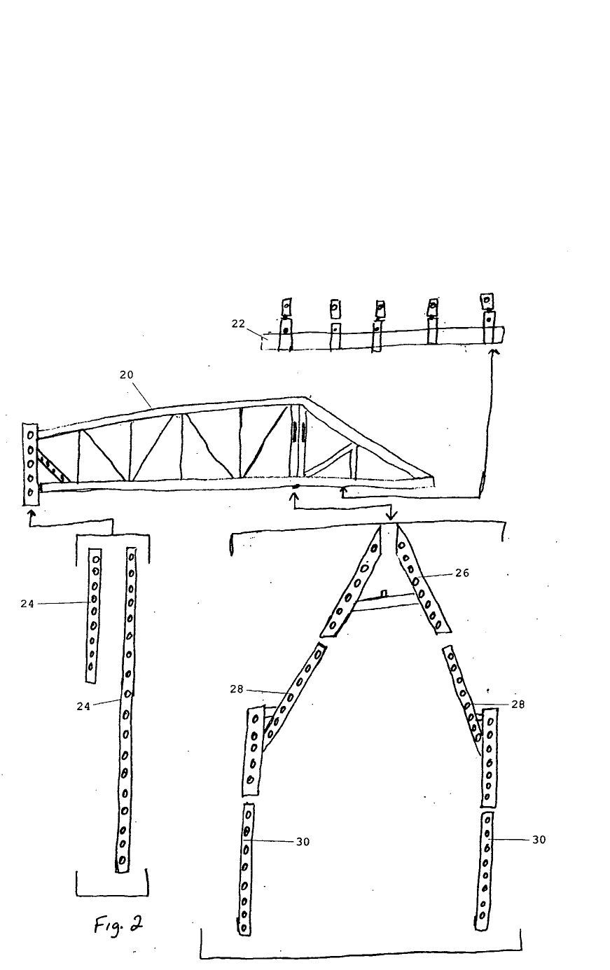

FIG. 2 is an exploded view as shown in FIG. 1, included are the following components: main frame 20, track 22, rear leg(S) 24, “A” frame of front support assembly 26, mid section leg(S) of front support assembly 28, lower leg(S) of front support assembly 30. The main frame 20 is assembled from various precut pieces into a template and is welded fabricated to form a one piece assembly. In accordance with this invention, the main frame 20 is shaped as shown in various figures for very specific functional reasons, they are as follows: starting at the rear end of the main frame is short length of 2.5″ telescoping tubing whereby the rear leg(S) 24 are connectedly attached and allows for height adjustment, the upper and lower rails are attached roughly near the ends of this short piece of end tubing to provide adequate space along the horizontal distance for insertion of tension, compression webs and the angle brace. The rear section is made a long as possible in relation to the front cantilevered portion so as to create enough leverage ratio to minimize uplift force on connection lag bolts and J-hook 48 and/or minimize amount ballast required at rear leg(S) 24 to offset uplift force and for ease of handling, transportation, shipping and set up within a minimum three foot by seven and half foot surface area. At the high point or peak location is a vertical member that provides the location for the welded tabs and the hole to receive the dowel pin is on the under side of the bottom rail at this location which provides the means of attachment and thus load support and transfer for the “A” frame of front support assembly 26. The front cantilevered portion is necessarily extended a short distance beyond the high point to create enough space to lift and keep objects and materials of a variety of sizes away from obstructions, wall surfaces etc while lifting or lowering a load. Reinforcement plates are added at the front end and peak because stresses are greatest at these locations.

The track 22 is a specific length to allow space for attaching angle brace “a” 40 and inserting either the electromechanical hoist adapter assembly 32 or mechanical hoist adapter assembly 38, (either are retained in the track at the rear by a clevis pin and at the front end by a bolt and nylock nut) and runs to a point extending to end of front cantilevered portion. The track 22 (Unistrut part number P1000) is supported by back to back U-shaped brackets (Unistrut part number P1834) specially manufactured for this purpose and spaced according to their design load specifications, assembly is attached to main frame 20 through holes in lower rail of the main frame 20 and support brackets by means of locking pins and brackets are secured to each other by a bolt with a nylock nut.

The rear leg(S) 24 are standard length (and can be cut to custom length up to twenty feet) and telescopically adjust in one inch increments to meet set up requirement and to allow for leveling the track 22, a track set level prevents lifting device/load from unwanted travel due to effect of gravity.

The “A” frame of front support assembly 26 is welded fabricated whereby angled sections are welded to a horizontal cross tube. Multiple functions are integrated into this assembly: 1. This assembly slides into position on main frame 20 with an alignment dowel located on the cross tube which engages a hole on the underside of the lower main frame 20 rail tube and upper most portion of angled section slides in between a pair of welded tabs on both sides of main frame 20 whereby locking pins are inserted which serves to securely connect it to main frame 20. 2. Whereby the angled sections provide means to slide upper portion of mid section leg(S) of front support assembly 28 in or outward to desired location and locking pins are inserted, this adjustment facilitates more or less distance between lower leg(S) whereas legs can spread from approximately three to six feet apart to a customized distance. 3. Whereby at bottom of “A” frame of front support assembly 26 angled sections provide means to connect mid section leg(S) 4. A detachable assembly also makes main frame lighter to handle and requires less space necessary for shipping as compared to it being permanently attached to main frame 20. Where other design methods of connection could facilitate same purpose described.

The mid section leg(S) of front support assembly 28 are welded fabricated and serve multiple purposes: 1. To provide a transition from angled mid section leg(S) of front support assembly 28 to the vertical lower leg(S) of front support assembly 30. 2. Whereas its upper angled portion is telescopically inserted into the lowest portion of “A” frame of front support assembly 26 angled legs, whereby locking pins are inserted at desired setting. 3. Whereas the vertical telescoping tube provides telescoping connection for the lower leg(S) of front support assembly 30.

The lower leg(S) of front support assembly 30 are a standard or custom length of telescoping tubing and serve multiple purposes: 1. Provide structural load support and transfer from upper two leg sections. 2. Provide height adjustment. 3. Whereas to provide further track 22 adjustment to a level position for final setup and operation, also as referenced in rear leg(S) 24 function described above. 4. Whereby attachment adapter may be interchangeably secured with locking pins at the lowest portion of legs, according to connections diagram of this application.

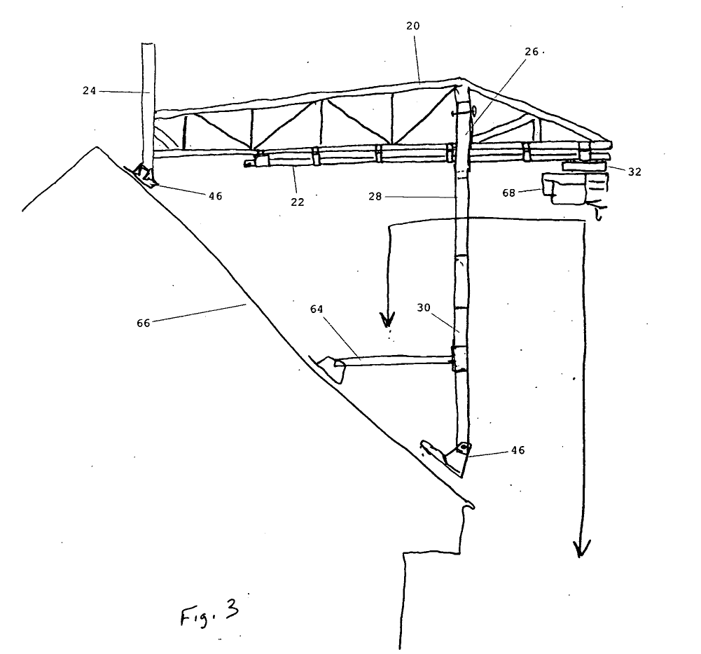

FIG. 3 is a left elevation view of an alternate embodiment in accordance of the invention assembled for typical sloped surface 66 setup and use, and also includes location where an electromechanical hoist mfg. by others 68 or mechanical hoist adapter assembly 38 is attached/used on this invention.

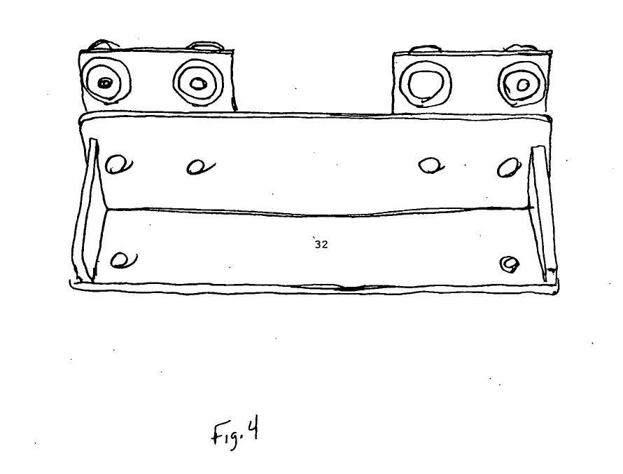

FIG. 4 is a perspective view of a electromechanical hoist adapter assembly 32. This adapter is welded fabricated using two short lengths of steel angle with angled reinforcement plate welded at end of each piece, and is bolted through to two trolley wheels (Unistrut part number P2950). Wherein trolley wheels are manufactured by Unistrut Corporation. Whereas the combination of this assembly facilitates a physical connection between a given electromechanical wire rope hoist mfg. by others 68 and the track 22.

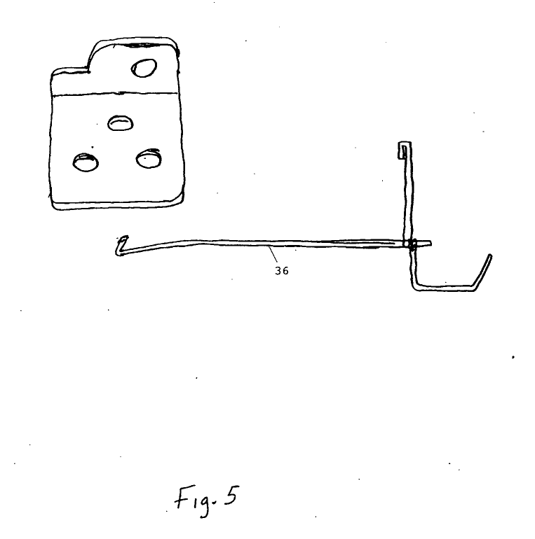

FIG. 5 is a perspective view of a hoist control handle and attachment bracket 36. These two components are custom formed and welded or threaded connected of any suitable material, ideally steel. These two components have multiple combination of functions: 1. Together with bracket bolted to base of hoist mfg. by others 68 it serves to connect control handle on the electromechanical wire rope hoist mounting base. 2. Provides extended reach to move either hoist attachment along track from either end whether load is attached or not. 2. Whereby handle alone without attachment bracket is securely attached to mechanical hoist adapter assembly 38 with same function. 3. Whereas handle in either configuration provides support function for portion of power cord and and up/down control wand of electromechanical hoist by means of specific wire supports manufactured by others. 4. Whereas upper handle hook provides a gravity engaged position lock, to maintain the position of a lift device anywhere along length of track 22, the hook is inserted into holes provided on the top of the lower rail of main frame, whether it be Patented square fit tube product or standard steel tube with pre-drilled holes provided at specific locations.

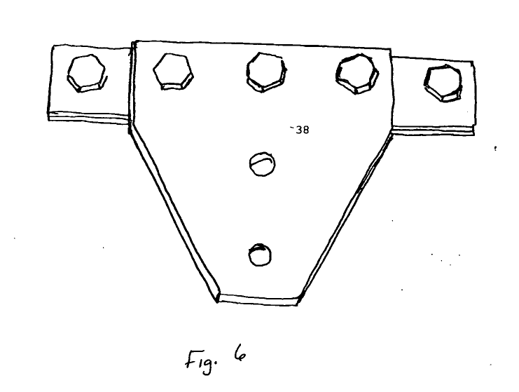

FIG. 6 is a left perspective view of a mechanical hoist adapter assembly 38. This assembly is combination of “flat plates” mechanically connected by nylock nuts and bolts to two trolley wheels (Part number P295, P1941 and P1726). Flat plates and trolley wheels are manufactured by Unistrut Corporation. This combination of components in addition to a lift pin inserted across holes of the triangular plate provide a means to attach a hook from a mechanical hoist device manufactured by others.

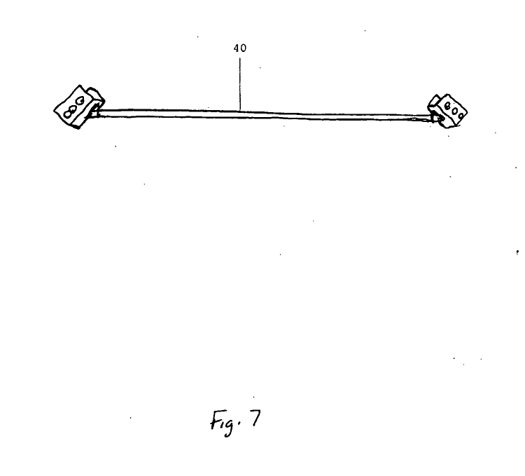

FIG. 7 is a perspective view of an angle brace “a” 40 This brace is welded fabricated from a solid (or hollow) length of round steel rod, two short lengths of Patented telescoping tubing with one side removed and ground smooth at each end at approximately a forty five degree angle, additionally a small angular piece of tubing is welded to form a reinforcement of connection of each end of brace. The function of this brace is to provide additional stability to rear leg in the front to rear direction. It is typically used on flat surface configuration and long rear leg(S) 24 is attached

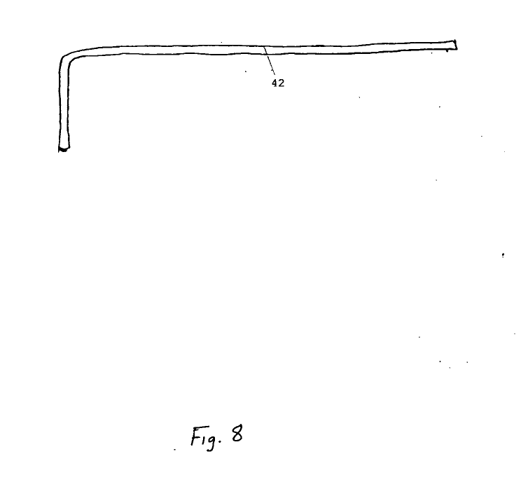

FIG. 8 is an elevation view of a power cord support arm 42. This arm is form fabricated from a length of solid rod of sufficient strength to support power cord. It is inserted into hole provided at a specific location on the top side of the upper rail of the main frame. Gravity holds it in place. The arm rotates and supports power cord as hoisting device travels back and forth along tack.

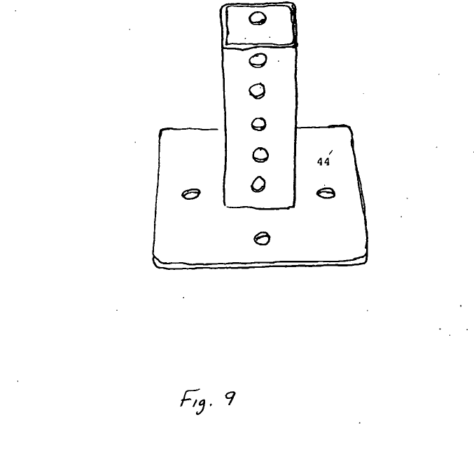

FIG. 9 is a perspective view of a flat surface leg attachment adapter 44. This optional adapter is welded fabricated from a short length of Patented square fit tubing and a custom fabricated flat metal plate. The short length of tube telescopically slides into (or over) lower leg(S) of front support assembly 30 and is securely attached by a locking pin. Its purpose is to provide means for attaching legs to any flat surface. Holes are provided for multiple purposes: 1. A lag bolt connection or combination of J-bolt and lag bolt connection. Also can be used to create a base for attaching optional casters in conjunction with ballast adapter 58. Optional flat plates are provided on ballast adapter for two casters for a total of four casters of sufficient load capacity to create a mobile lift.

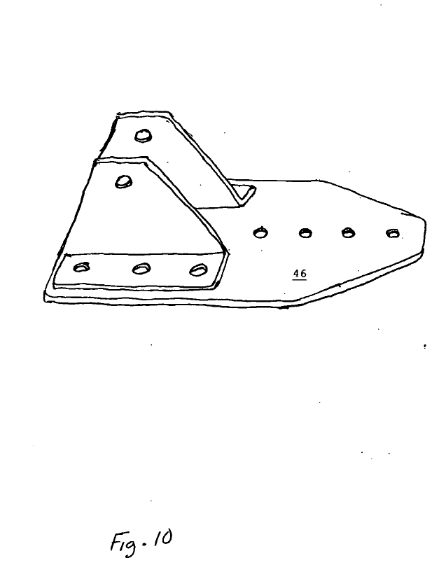

FIG. 10 is a perspective view of a pivoting sloped surface leg attachment adapter 46 This optional adapter is welded fabricated from two Unistrut manufactured right angle brackets (part number P1728) or custom fabricated right angle brackets of sufficient strength and a base plate with holes for lag bolts and or J-bolt and is intended only for sloped use set up configuration of crane. Installation of i-bolt required on rear leg(S) 24. Additionally one of these pivoting adapters is used with optional angle brace “B” 62.

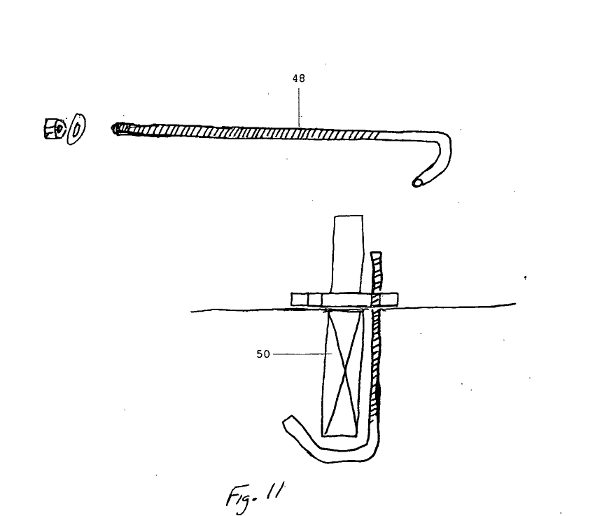

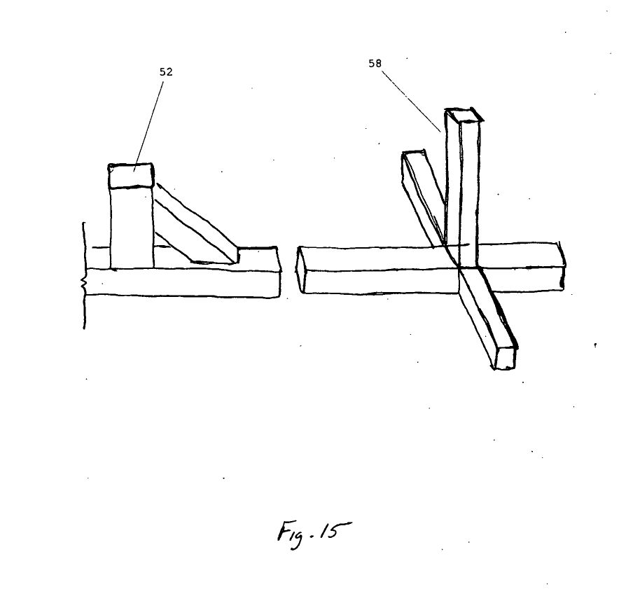

FIG. 11 is an elevation view of a J-hook 48 attachment bolt and an alternate view of an example of a structural member i.e. roof rafter 50 connection at rear leg. This optional component is custom fabricated and threaded (with nut and washer) for use on attachment adapters described in FIGS. 9, 10, 13 and 15. In FIG. 15 truck bed adapter 56 a direct bolt through metal base plate and truck frame is an acceptable alternate method of physical attachment to truck bed bolts.

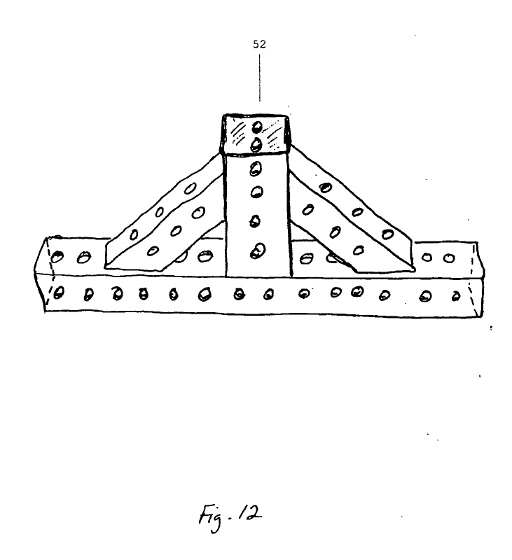

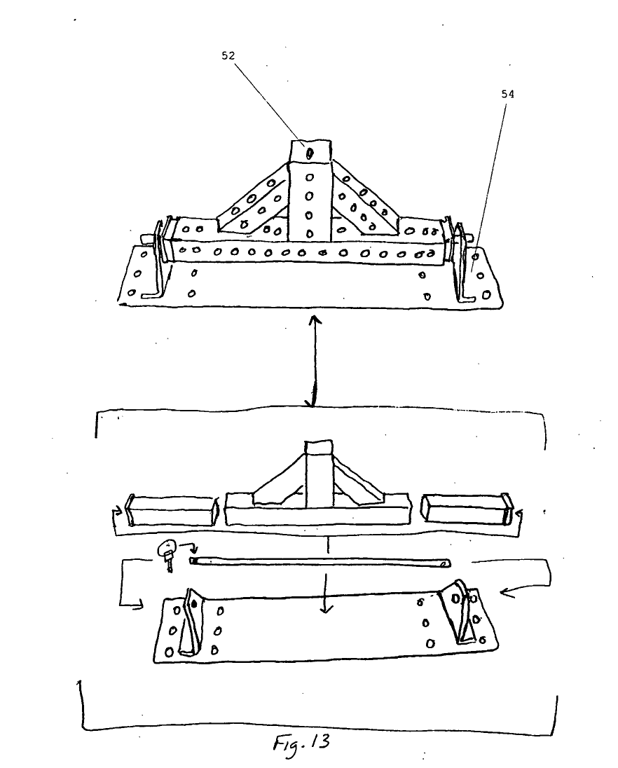

FIG. 12 is a perspective view of a universal tee adapter. This element is welded fabricated from Patented Unistrut telescoping tubing and is used in combination with elements in FIGS. 13, 14, 15, and 16. Its has multiple functions: 1. Provides a common method of attachment of universal tee adapter to either front or real legs. 2. Provides means of attachment for optional combination of previously mentioned adapters. 3. It is securely attached to legs and optional adapters by inserting locking pins. 4. Provides additional directional stability to various combinations of adapters and leg(S).

FIG. 13 is a perspective view of a pivoting two point connection adapter 54. This optional adapter is welded fabricated from Unistrut manufactured right angle brackets (part number P1728) in combination with a custom fabricated base plate. Base plate has holes provided at sixteen and twenty four inches on center. This adapter additionally utilizes the universal tee adapter, along with two short lengths of tubes with an end plate welded on one end of each tube (and each plate has a hole for pivot connecting rod to slide through) to create a pivotal support, a steel rod that is retained by lynch pins at each end of pivot rod and connects all sub components into one adapter. The support tubes are made from Patented telescoping tube that slide into base and spreads in or out to meet inside of base brackets. This adapter is attached to two structural members, either with lag bolts or a combination of lag bolts and J-hook 48 as shown singly in J-hook 48 alternate view in FIG. 11.

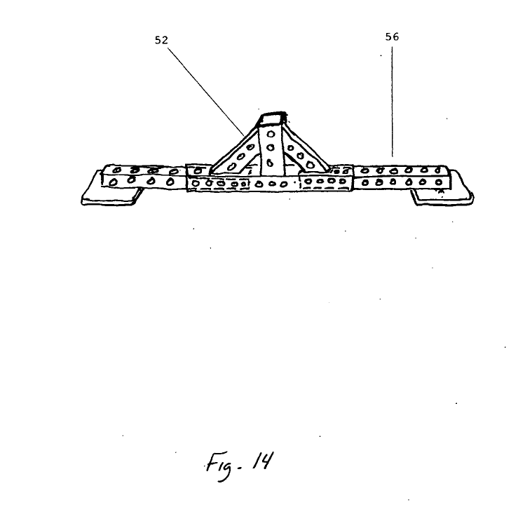

FIG. 14 is a perspective view of a truck bed adapter 56. This optional adapter is welded fabricated from Patented telescoping tubing and a custom fabricated base plate which two of these are inserted into the universal tee adapter and securely attached together with locking pins to create and adapter to secure rear leg(S) 24 to a truck bed or other flat surfaces. It is secured to mounting surface by using either method of bolt through to structural frame rails or J-bolts.

FIG. 15 is a perspective view of a ballast adapter 58. This optional adapter is welded fabricated from Unistrut telescoping tubing and or a combination of square tubing and telescoping tubing. Telescoping tubing is required at connection to universal tee adapter. The combination provides means of attaching ballast at the lower rear leg(S) 24 as a substitute for mechanical connection of the rear leg, which offsets uplift force of loads lifted and carried by crane. Attachment to legs and described adapter is done by inserting a locking pin at each point of attachment. Optional base plates welded to bottom of adapter provide means of attaching caster for a mobile set up configuration of crane.

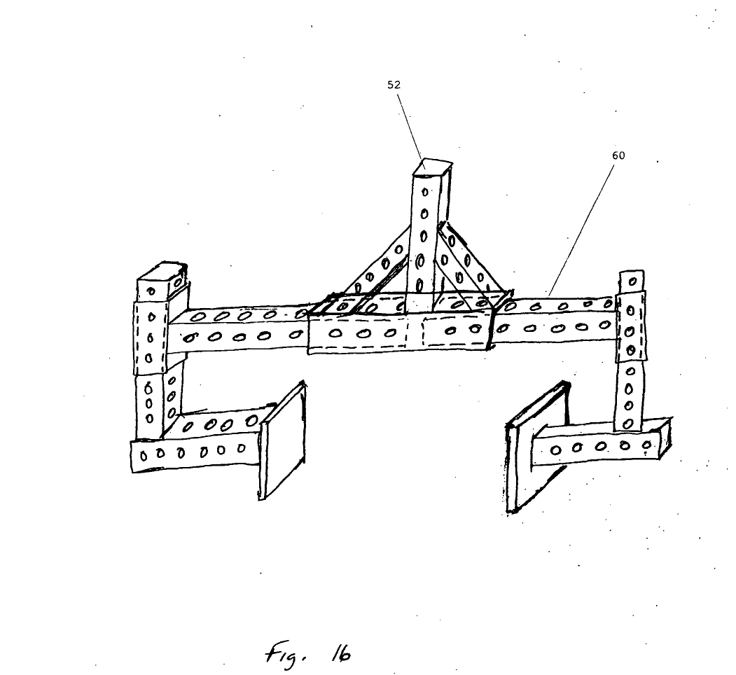

FIG. 16 is a perspective view of a parapet wall adapter 60. This optional adapter is welded fabricated from Patented telescoping tubing and custom made flat plates. It is used in conjunction with the universal tee adapter. It provides stable non-movable and adjustable to various thickness of parapet walls support at the two front legs and sets on top of the parapet wall. It is securely attached to two front leg(S) and adapters with locking pins. Additionally at the rear leg in this configuration of set up would require an optional attachment adapter as shown in FIG. 9, 10 or 13.

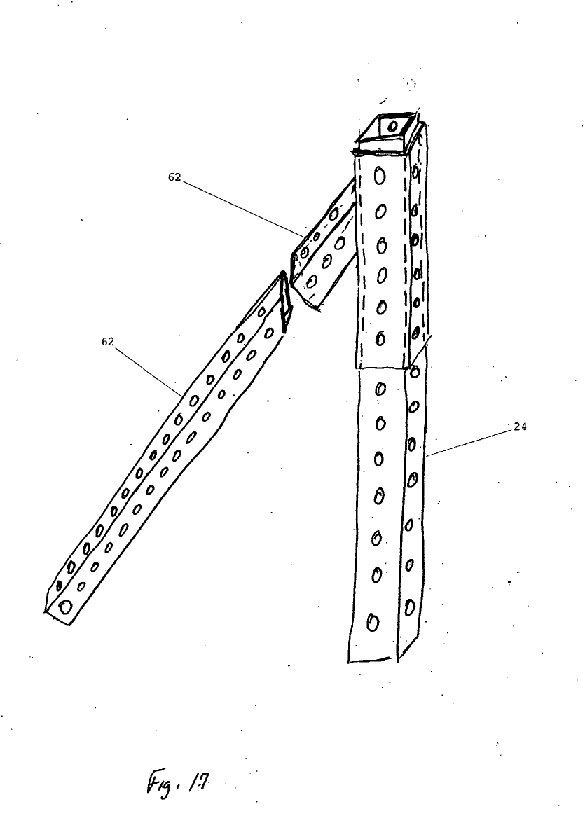

FIG. 17 is a perspective view of an angle brace “B” 62 This optional element is welded fabricated and is comprised of several components; 1. A sliding fixture that is installed on the rear leg(S) 24 2. The sliding fixture has a short angular extension to receive a long extension tube that telescopically connects to the angular extension of the sliding fixture. 3. The optional pivoting adapter as described in FIG. 10 attaches to end of extension tube. Its purpose is to provide side to side directional stability to rear leg when set up configuration requires rear leg to be fully (or nearly fully) extended. All components of this brace are secured attached together by inserting locking pins at points of connection. Base plate is attached to mounting surface by using lag bolts and or a combination of lag bolts and J-hook 48.

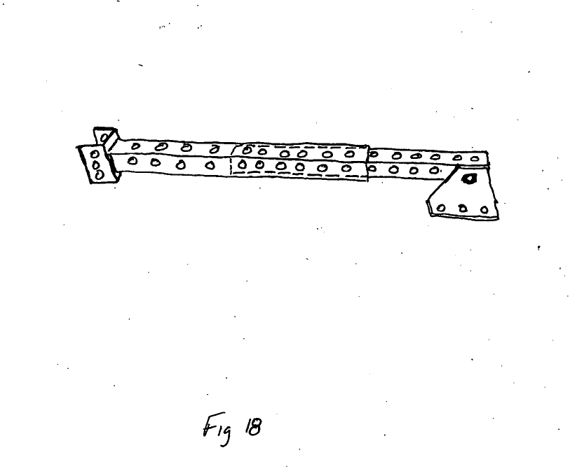

FIG. 18 is a perspective view of an adjustable platform support bracket(S) 64. This adapter is welded fabricated from Patented telescoping tubing and Unistrurt right angle brackets part number P1728. Each bracket is comprised of two lengths of telescoping tubing; at end of one length a short length of telescoping tubing with one side removed and ground smooth is then welded to end to form a three sided attachment bracket; whereas the second length two right angle brackets are attached to form a pivoting support/attachment bracket. Pivoting brackets are secured together with a spacer tube and a nylock nut and bolt. The pair of right angle brackets is attached to the one end with a second nylock nut and bolt. Two brackets are attached level in both directions which provide support and means of attachment for scaffold planks so as to create an elevated staging surface. One of these brackets are attached to each of the front legs. Brackets are attached at two points: 1. At two front legs with locking pins after setting at desired height. 2. at sloped surface after extending horizontally so pivoting bracket end meets and sets on mounting surface and installing lag bolts into mounting surface.

Thus, in summary, it can be seen that what is provided in this invention is a transportable, transformable, telescoping, lightweight jib-crane that has both form and function that is easy to use, set up and “brake down” in minutes by one person if necessary.

The submitted design and functional utility of this piece of equipment and all of its versatility was created by the inventor from experimentation with a single previous prototype and its logistical short comings. The use of the original prototype allowed the inventor to further refine the design into its present form. Both designs were a result of a set of criteria (questions) established to create all elements, the questions are as follows:

1. How can a device be made to replace a human carrying a bundle of shingles (or equipment etc.) from a truck (or ground), up a ladder (however high) and then set it down onto an elevated (roof) surface or the inverse?

2. How could it function and be adjustable so it could be set up on a flat surfaces (flat roof, truck bed, deck) or any roof pitch/sloped or irregular surface or any combination thereof?

3. How can it be made light enough so one person of average strength could set it up and break it down anywhere it's desired for use, in as little time as possible and, easily handle all of its components.

4. How could it be safely attached where it is to be used.

5. How could loads be moved back and forth across line of support i.e. building line, edge of roof, deck; loft, truck bed?

6. How would likely loads with a size range 5′ to 6′ in diameter or light construction material etc. weighing under a half ton not require a large surface area for setup?

7. How could it be produced and sold cost effectively?

8. What is the sequence of physical events necessary for a human to accomplish moving any object anywhere at any time.

Further, it was deduced that all elements required to create this invention would be derived from a combination of multiple products presently produced in mass quantities, the application of mathematical building design theories and standard practices that have been in existence for a very long time. Therefore it is not any one theory or practice in particular but the combination together that make this invention possible and therefore novel. Each and every element of this invention has a necessary and functional purpose in order to meet the design criteria questions referenced above.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A “mdporta-lift” transportable, transformable, telescoping, lightweight, cantilevered trolley track, half ton capacity material conveying lift. for facilitation of conveying objects via mechanical or electromechancial hoisting device by lifting up; moving latteraly along track and then lowering load (or the inverse) from a variety of elevated surfaces (using accessory attachment adapters) i.e. almost any sloped or flat roof; loft/deck; full size pickup/utility truck; watercraft/docks, on casters or a fixed location, that is quick and easy to set-up and dissasemble by one or more person, that could greatly reduce worker's long and short term injuries and greatly reduce labor costs and increase commercial profitibility, at a reasonable price, comprising:
means for providing main structural support for load and attachment of legs, track assembly and other accessories;
means for providing means to connect a mechanical or electromechanical lifting device and moving the load latteraly back and forth from one end to the other, detachably connected to said means for providing main structural support for load and attachment of legs, track assembly and other accessories;
means for providing load support at rear of main frame; for adjustability of rear leg length for various sloped or flat surfaces use and connecting of accessory adapters to leg, telescopically connected to said means for providing main structural support for load and attachment of legs, track assembly and other accessories;
means for providing load support and stability at front of crane, connecting middle and lower leg components to main frame, detachably connected to said means for providing main structural support for load and attachment of legs, track assembly and other accessories;
means for providing support, connection and incremental adjustability to lower leg section as well as incremental width adjustment between lower legs and to transition from angle to vertical leg alignment on the front support assembly, telescopically connected to said means for providing load support and stability at front of crane, connecting middle and lower leg components to main frame;
means for providing load support on the front support assembly, incremental height adjustments, means to connect accessory attachment brackets, telescopically connected to said means for providing support, connection and incremental adjustability to lower leg section as well as incremental width adjustment between lower legs and to transition from angle to vertical leg alignment on the front support assembly;
means for provide means to mount/attach electromechanical hoist to trolley track, alternately connected to said means for providing means to connect a mechanical or electromechanical lifting device and moving the load latteraly back and forth from one end to the other;
means for control hoist along its path of tavel on trolley track and is interchangeable with mechanical hoist adapter bracket and also to secure electromechanical hoist control and power cable;
means for provide means for attachment of most any hook type manual mechanical hoisting device to trolley track, detachably connected to said means for control hoist along its path of tavel on trolley track and is interchangeable with mechanical hoist adapter bracket and also to secure electromechanical hoist control and power cable, and alternately connected to said means for providing means to connect a mechanical or electromechanical lifting device and moving the load latteraly back and forth from one end to the other;
means for provides support and movement of power cord and keeps cord elevated above track assembly as electromechanical hoist is moved back and forth along trolley track, rotatably inserted to said means for providing main structural support for load and attachment of legs, track assembly and other accessories;
means for providing means of optional attachment on an angled flat surface i.e. typical residential home roof, pivotally connected to said means for providing load support on the front support assembly, incremental height adjustments, means to connect accessory attachment brackets, and pivotally connected to said means for providing load support at rear of main frame; for adjustability of rear leg length for various sloped or flat surfaces use and connecting of accessory adapters to leg;
means for provide mechanical connection to a structural member on rear leg adapters, threadably connected to said means for providing means of optional attachment on an angled flat surface i.e. typical residential home roof;
means for providing one common base that other adapters can be attached to and incrementaly adjusted i.e. adapters are: truck bed; ballast; pivoting two point adapter; parapetwall;
means for providing a means to make connection to two structural members using lag bolts and j-hooks on any surface angle on the rear leg of the crane, telescopically coupled to said means for providing one common base that other adapters can be attached to and incrementaly adjusted i.e. adapters are: truck bed; ballast; pivoting two point adapter; parapetwall, threadably connected to said means for provide mechanical connection to a structural member on rear leg adapters, and detachably connected to said means for providing load support at rear of main frame; for adjustability of rear leg length for various sloped or flat surfaces use and connecting of accessory adapters to leg;
means for providing means of attaching rear leg of crane to pick up truck bed (or flat surface) and is incrementaly adjustable in width so j or u bolts can be installed through end plate of adapter to make secure connection to various width of vehicle frames, telescopically interconnected to said means for providing one common base that other adapters can be attached to and incrementaly adjusted i.e. adapters are: truck bed; ballast; pivoting two point adapter; parapetwall, threadably connected to said means for provide mechanical connection to a structural member on rear leg adapters, and detachably connected to said means for providing load support at rear of main frame; for adjustability of rear leg length for various sloped or flat surfaces use and connecting of accessory adapters to leg;
means for provide means to attach and support ballast at rear leg, telescopically interconnected to said means for providing one common base that other adapters can be attached to and incrementaly adjusted i.e. adapters are: truck bed; ballast; pivoting two point adapter; parapetwall, and detachably connected to said means for providing load support at rear of main frame; for adjustability of rear leg length for various sloped or flat surfaces use and connecting of accessory adapters to leg;
means for providing a means to mount front support assembly legs on top of a parapet wall, telescopically interconnected to said means for providing one common base that other adapters can be attached to and incrementaly adjusted i.e. adapters are: truck bed; ballast; pivoting two point adapter; parapetwall, and detachably connected to said means for providing load support on the front support assembly, incremental height adjustments, means to connect accessory attachment brackets;
means for providing incrementaly adjustable latteral bracing from side to side on rear leg and is used in conjuction with a pivoting adapter bracket as a means of attachment to surface, telescopically connected to said means for providing load support at rear of main frame; for adjustability of rear leg length for various sloped or flat surfaces use and connecting of accessory adapters to leg; and
means for providing support for platform planks that are adjustable in height and width, one end of bracket has a pivoting set of brackets that allow attachment to a sloped surface, telescopically connected to said means for providing load support on the front support assembly, incremental height adjustments, means to connect accessory attachment brackets.

2. The “mdporta-lift” transportable, transformable, telescoping, lightweight, cantilevered trolley track, half ton capacity material conveying lift. in accordance with claim 1, wherein said means for providing load support at rear of main frame; for adjustability of rear leg length for various sloped or flat surfaces use and connecting of accessory adapters to leg comprises a rear leg(s).

3. The “mdporta-lift” transportable, transformable, telescoping, lightweight, cantilevered trolley track, half ton capacity material conveying lift. in accordance with claim 1, wherein said means for providing load support and stability at front of crane, connecting middle and lower leg components to main frame comprises a “a” frame of front support assembly.

4. The “mdporta-lift” transportable, transformable, telescoping, leightweight, cantilevered trolley track, half ton capacity material conveying lift. in accordance with claim 1, wherein said means for providing support, connection and incremental adjustability to lower leg section as well as incremental width adjustment between lower legs and to transition from angle to vertical leg alignment on the front support assembly comprises a mid section leg(s) of front support assembly.

5. The “mdporta-lift” transportable, transformable, telescoping, leightweight, cantilevered trolley track, half ton capacity material conveying lift. in accordance with claim 1, wherein said means for providing load support on the front support assembly, incremental height adjustments, means to connect accessory attachment brackets comprises a patented telescoping steel tubing lower leg(s) of front support assembly.

6. The “mdporta-lift” transportable, transformable, telescoping, leightweight, cantilevered trolley track, half ton capacity material conveying lift. in accordance with claim 1, wherein said means for control hoist along its path of tavel on trolley track and is interchangeable with mechanical hoist adapter bracket and also to secure electromechanical hoist control and power cable comprises a hoist control handle and attachment bracket.

7. The “mdporta-lift” transportable, transformable, telescoping, leightweight, cantilevered trolley track, half ton capacity material conveying lift. in accordance with claim 1, wherein said means for provides support and movement of power cord and keeps cord elevated above track assembly as electromechanical hoist is moved back and forth along trolley track comprises a power cord support arm.

8. The “mdporta-lift” transportable, transformable, telescoping, leightweight, cantilevered trolley track, half ton capacity material conveying lift. in accordance with claim 1, wherein said means for providing means of optional attachment on an angled flat surface i.e. typical residential home roof comprises a pivoting sloped surface leg attachment adapter.

9. The “mdporta-lift” transportable, transformable, telescoping, leightweight, cantilevered trolley track, half ton capacity material conveying lift. in accordance with claim 1, wherein said means for provide mechanical connection to a structural member on rear leg adapters comprises a j-hook.

10. The “mdporta-lift” transportable, transformable, telescoping, leightweight, cantilevered trolley track, half ton capacity material conveying lift. in accordance with claim 1, wherein said means for providing one common base that other adapters can be attached to and incrementaly adjusted i.e. adapters are: truck bed; ballast; pivoting two point adapter; parapetwall comprises a patented telescoping steel tubing universal tee adapter.

11. The “mdporta-lift” transportable, transformable, telescoping, leightweight, cantilevered trolley track, half ton capacity material conveying lift. in accordance with claim 1, wherein said means for providing a means to make connection to two structural members using lag bolts and j-hooks on any surface angle on the rear leg of the crane comprises a patented telescoping steel tubing pivoting two point connection adapter.

12. The “mdporta-lift” transportable, transformable, telescoping, leightweight, cantilevered trolley track, half ton capacity material conveying lift. in accordance with claim 1, wherein said means for providing means of attaching rear leg of crane to pick up truck bed (or flat surface) and is incrementaly adjustable in width so j or u bolts can be installed through end plate of adapter to make secure connection to various width of vehicle frames comprises a patented telescoping steel tubing truck bed adapter.

13. The “mdporta-lift” transportable, transformable, telescoping, leightweight, cantilevered trolley track, half ton capacity material conveying lift. in accordance with claim 1, wherein said means for provide means to attach and support ballast at rear leg comprises a patented telescoping steel tubing ballast adapter.

14. The “mdporta-lift” transportable, transformable, telescoping, leightweight, cantilevered trolley track, half ton capacity material conveying lift. in accordance with claim 1, wherein said means for providing a means to mount front support assembly legs on top of a parapet wall comprises a patented telescoping steel tubing parapet wall adapter.

15. The “mdporta-lift” transportable, transformable, telescoping, leightweight, cantilevered trolley track, half ton capacity material conveying lift. in accordance with claim 1, wherein said means for providing incrementaly adjustable latteral bracing from side to side on rear leg and is used in conjuction with a pivoting adapter bracket as a means of attachment to surface comprises a patented telescoping steel tubing angle brace “b”.

16. The “mdporta-lift” transportable, transformable, telescoping, leightweight, cantilevered trolley track, half ton capacity material conveying lift. in accordance with claim 1, wherein said means for providing support for platform planks that are adjustable in height and width, one end of bracket has a pivoting set of brackets that allow attachment to a sloped surface comprises a patented telescoping steel tubing platform support bracket(s).

17. A “mdporta-lift” transportable, transformable, telescoping, leightweight, cantilevered trolley track, half ton capacity material conveying lift. for facilitation of conveying objects via mechanical or electromechancial hoisting device by lifting up; moving latteraly along track and then lowering load (or the inverse) from a variety of elevated surfaces (using accessory attachment adapters) i.e. almost any sloped or flat roof; loft/deck; full size pickup/utility truck; watercraft/docks, on casters or a fixed location, that is quick and easy to set-up and dissasemble by one or more person, that could greatly reduce worker's long and short term injuries and greatly reduce labor costs and increase commercial profitibility, at a reasonable price, comprising:
a patented square fit tubing, holes 7/16″ on four sides main frame, for providing main structural support for load and attachment of legs, track assembly and other accessories;
a steel patented track and support brackets mfg by others track, for providing means to connect a mechanical or electromechanical lifting device and moving the load latteraly back and forth from one end to the other, detachably connected to said main frame;
a rear leg(s), for providing load support at rear of main frame; for adjustability of rear leg length for various sloped or flat surfaces use and connecting of accessory adapters to leg, telescopically connected to said main frame;
a “a” frame of front support assembly, for providing load support and stability at front of crane, connecting middle and lower leg components to main frame, detachably connected to said main frame;
a mid section leg(s) of front support assembly, for providing support, connection and incremental adjustability to lower leg section as well as incremental width adjustment between lower legs and to transition from angle to vertical leg alignment on the front support assembly, telescopically connected to said “A” frame of front support assembly;
a patented telescoping steel tubing lower leg(s) of front support assembly, for providing load support on the front support assembly, incremental height adjustments, means to connect accessory attachment brackets, telescopically connected to said mid section leg(s) of front support assembly;
an electromechanical hoist adapter assembly, for provide means to mount/attach electromechanical hoist to trolley track, alternately connected to said track;
a hoist control handle and attachment bracket, for control hoist along its path of tavel on trolley track and is interchangeable with mechanical hoist adapter bracket and also to secure electromechanical hoist control and power cable;
a mechanical hoist adapter assembly, for provide means for attachment of most any hook type manual mechanical hoisting device to trolley track, detachably connected to said hoist control handle and attachment bracket, and alternately connected to said track;
a power cord support arm, for provides support and movement of power cord and keeps cord elevated above track assembly as electromechanical hoist is moved back and forth along trolley track, rotatably inserted to said main frame;
a pivoting sloped surface leg attachment adapter, for providing means of optional attachment on an angled flat surface i.e. typical residential home roof, pivotally connected to said lower leg(s) of front support assembly, and pivotally connected to said rear leg(s);
a j-hook, for provide mechanical connection to a structural member on rear leg adapters, threadably connected to said pivoting sloped surface leg attachment adapter;
a patented telescoping steel tubing univirsal tee adapter, for providing one common base that other adapters can be attached to and incrementaly adjusted i.e. adapters are: truck bed; ballast; pivoting two point adapter; parapetwall;
a patented telescoping steel tubing pivoting two point connection adapter, for providing a means to make connection to two structural members using lag bolts and j-hooks on any surface angle on the rear leg of the crane, telescopically coupled to said univirsal tee adapter, threadably connected to said J-hook, and detachably connected to said rear leg(s);
a patented telescoping steel tubing truck bed adapter, for providing means of attaching rear leg of crane to pick up truck bed (or flat surface) and is incrementaly adjustable in width so j or u bolts can be installed through end plate of adapter to make secure connection to various width of vehicle frames, telescopically interconnected to said universal tee adapter, threadably connected to said J-hook, and detachably connected to said rear leg(s);
a patented telescoping steel tubing ballast adapter, for provide means to attach and support ballast at rear leg, telescopically interconnected to said universal tee adapter, and detachably connected to said rear leg(s);
a patented telescoping steel tubing parapet wall adapter, for providing a means to mount front support assembly legs on top of a parapet wall, telescopically interconnected to said universal tee adapter, and detachably connected to said lower leg(s) of front support assembly;
a patented telescoping steel tubing angle brace “b”, for providing incrementaly adjustable latteral bracing from side to side on rear leg and is used in conjuction with a pivoting adapter bracket as a means of attachment to surface, telescopically connected to said rear leg(s); and
a patented telescoping steel tubing platform support bracket(s), for providing support for platform planks that are adjustable in height and width, one end of bracket has a pivoting set of brackets that allow attachment to a sloped surface, telescopically connected to said lower leg(s) of front support assembly.

18. The “mdporta-lift” transportable, transformable, telescoping, leightweight, cantilevered trolley track, half ton capacity material conveying lift. as recited in claim 17, further comprising:
an angle brace “a”, for providing optional (front to rear) latteral support for rear leg when rear leg has to be fully extended on a given setup, angularly connected to said main frame.

19. The “mdporta-lift” transportable, transformable, telescoping, lightweight, cantilevered trolley track, half ton capacity material conveying lift. as recited in claim 17, further comprising:
a patented telescoping steel tubing flat surface leg attachment adapter, for providing a means to attach crane legs to flat surface or to attach casters, three of these adapters are necessary for fixed location and for mobile use a combination these two are required for casters on front two legs in addition to an additional rear leg adapter that includes ballast weight. rear ballast adapter may use two casters, detachably connected to said rear leg(s), detachably connected to said lower leg(s) of front support assembly, and threadably connected to said J-hook.

20. The “mdporta-lift” transportable, transformable, telescoping, leightweight, cantilevered trolley track, half ton capacity material conveying lift. as recited in claim 18, further comprising:
a patented telescoping steel tubing flat surface leg attachment adapter, for providing a means to attach crane legs to flat surface or to attach casters, three of these adapters are necessary for fixed location and for mobile use a combination these two are required for casters on front two legs in addition to an additional rear leg adapter that includes ballast weight. rear ballast adapter may use two casters, detachably connected to said rear leg(s), detachably connected to said lower leg(s) of front support assembly, and threadably connected to said J-hook.

21. A “mdporta-lift” transportable, transformable, telescoping, leightweight, cantilevered trolley track, half ton capacity material conveying lift. for facilitation of conveying objects via mechanical or electromechancial hoisting device by lifting up; moving latteraly along track and then lowering load (or the inverse) from a variety of elevated surfaces (using accessory attachment adapters) i.e. almost any sloped or flat roof; loft/deck; full size pickup/utility truck; watercraft/docks, on casters or a fixed location, that is quick and easy to set-up and dissasemble by one or more person, that could greatly reduce worker's long and short term injuries and greatly reduce labor costs and increase commercial profitibility, at a reasonable price, comprising:
a patented square fit tubing, holes 7/16” on four sides main frame, for providing main structural support for load and attachment of legs, track assembly and other accessories;
a steel patented track and support brackets mfg by others track, for providing means to connect a mechanical or electromechanical lifting device and moving the load latteraly back and forth from one end to the other, detachably connected to said main frame;
a rear leg(s), for providing load support at rear of main frame; for adjustability of rear leg length for various sloped or flat surfaces use and connecting of accessory adapters to leg, telescopically connected to said main frame;
a “a” frame of front support assembly, for providing load support and stability at front of crane, connecting middle and lower leg components to main frame, detachably connected to said main frame;
a mid section leg(s) of front support assembly, for providing support, connection and incremental adjustability to lower leg section as well as incremental width adjustment between lower legs and to transition from angle to vertical leg alignment on the front support assembly, telescopically connected to said “A” frame of front support assembly;
a patented telescoping steel tubing lower leg(s) of front support assembly, for providing load support on the front support assembly, incremental height adjustments, means to connect accessory attachment brackets, telescopically connected to said mid section leg(s) of front support assembly;
an electromechanical hoist adapter assembly, for provide means to mount/attach electromechanical hoist to trolley track, alternately connected to said track;
a hoist control handle and attachment bracket, for control hoist along its path of tavel on trolley track and is interchangeable with mechanical hoist adapter bracket and also to secure electromechanical hoist control and power cable;
a mechanical hoist adapter assembly, for provide means for attachment of most any hook type manual mechanical hoisting device to trolley track, detachably connected to said hoist control handle and attachment bracket, and alternately connected to said track;
an angle brace “a”, for providing optional (front to rear) latteral support for rear leg when rear leg has to be fully extended on a given setup, angularly connected to said main frame;
a power cord support arm, for provides support and movement of power cord and keeps cord elevated above track assembly as electromechanical hoist is moved back and forth along trolley track, rotatably inserted to said main frame;
a patented telescoping steel tubing flat surface leg attachment adapter, for providing a means to attach crane legs to flat surface or to attach casters, three of these adapters are necessary for fixed location and for mobile use a combination these two are required for casters on front two legs in addition to an additional rear leg adapter that includes ballast weight. rear ballast adapter may use two casters, detachably connected to said lower leg(s) of front support assembly, and detachably connected to said rear leg(s);
a pivoting sloped surface leg attachment adapter, for providing means of optional attachment on an angled flat surface i.e. typical residential home roof, pivotally connected to said lower leg(s) of front support assembly, and pivotally connected to said rear leg(s);
a j-hook, for provide mechanical connection to a structural member on rear leg adapters, threadably connected to said pivoting sloped surface leg attachment adapter, and threadably connected to said flat surface leg attachment adapter;
a patented telescoping steel tubing universal tee adapter, for providing one common base that other adapters can be attached to and incrementaly adjusted i.e. adapters are: truck bed; ballast; pivoting two point adapter; parapetwall;
a patented telescoping steel tubing pivoting two point connection adapter, for providing a means to make connection to two structural members using lag bolts and j-hooks on any surface angle on the rear leg of the crane, telescopically coupled to said univirsal tee adapter, threadably connected to said J-hook, and detachably connected to said rear leg(s);
a patented telescoping steel tubing truck bed adapter, for providing means of attaching rear leg of crane to pick up truck bed (or flat surface) and is incrementaly adjustable in width so j or u bolts can be installed through end plate of adapter to make secure connection to various width of vehicle frames, telescopically interconnected to said universal tee adapter, threadably connected to said J-hook, and detachably connected to said rear leg(s);
a patented telescoping steel tubing ballast adapter, for provide means to attach and support ballast at rear leg, telescopically interconnected to said universal tee adapter, and detachably connected to said rear leg(s);
a patented telescoping steel tubing parapet wall adapter, for providing a means to mount front support assembly legs on top of a parapet wall, telescopically interconnected to said univirsal tee adapter, and detachably connected to said lower leg(s) of front support assembly;
a patented telescoping steel tubing angle brace “b”, for providing incrementaly adjustable latteral bracing from side to side on rear leg and is used in conjuction with a pivoting adapter bracket as a means of attachment to surface, telescopically connected to said rear leg(s); and
a patented telescoping steel tubing platform support bracket(s), for providing support for platform planks that are adjustable in height and width, one end of bracket has a pivoting set of brackets that allow attachment to a sloped surface, telescopically connected to said lower leg(s) of front support assembly.
